(19) United States
(12) Patent Application Publication
(10) Pub. No.: US 2006/0197989 A1
(43) Pub. Date: Sep. 7, 2006

(54) Multi-configured halftone system

(75) Inventor: Stephen K. Herron, Ladera Ranch, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Toshiba Corporation; Toshiba Tec Kabushiki Kaisha

(21) Appl. No.: 11/073,951

(22) Filed: Mar. 7, 2005

(51) Int. Cl. H04N 1/60; G06F 15/00

(52) U.S. Cl. 358/3.06; 358/1.9

(57) ABSTRACT

A hybrid halftoning system and method that provides for improved output image rendering. Electronic document data containing image data is segmented into several regions. These regions include a highlight region, a midtone region and a shadow region. Selected dithering schemes are applied to each of these regions. Dithering patterns applied to the highlight and shadow regions are chosen from dispersed dither patterns. Different dither patterns are then selectively applied to the midtone region. The midtone region is further divided into three regions, a first quarter-tone region, a second quarter-tone region, and a central midtone region. A selected dither pattern is provided to each of these subdivided midtone regions, including a selective application of an elliptical dither pattern.

### BACKGROUND OF THE INVENTION

The subject invention is directed to the art of document rendering, and is particularly adapted to generation of images by use of halftoning. It will be appreciated that the system is particularly advantageous in connection with generation of hard copy documents. However, it is to be appreciated further that the subject invention is suited to any visual rendering of a document in which linear density is traded for color or shading by use of a halftoning system.

Halftoning is widely used in connection with document rendering. Conventional documents, such as those rendered with laser printer or dot matrix printers, are formed by a series of spaced dots. In a black and white printer, the dots are typically formed from a black deposit on a white paper. In a color printer, the dots may be one of selected, available colors which are placed on paper. Such discrete dot placement is fully functional for generating high-resolution text or line art. However, it suffers in an ability to render pictorial representations of images, such as with a gray scale level for black and white printers, or a broad spectrum color image rendering for accurate color rendition in color printers. Regarding color printers, the human eye recognizes a substantial number of colors, while document rendering devices are limited in the number of available ink colors.

A halftoning system seizes upon a property of human visual perception, and trades linear image density for human perception of color or gray scale levels. This is accomplished by generating a super cell or super pixel which is formed as a matrix or array of dots, or even smaller cells, which can be output from the rendering device. For example, if a printer is able to generate 600 dots per inch (“DPI”), a one inch by one inch area is suitably divided into a 16×16 grid of super cells. With this representative rendering, there would be ten super cells per inch. Various combinations of dot patterns or color patterns, provided within each super pixel and each sub cell, causes the human mind to assign a gray scale level or color level to that super pixel. In the event of a color rendering, various combinations and sub-combinations of available colors can generate a mental image of colors that are not provided directly in the document rendering device.

Many current document rendering systems use halftone image generation. Today, many such rendering systems employ a Type 3 PostScript (a trademark of Adobe Systems) system. For all conventionally used halftoning, there are differences that are manifested as trade offs between artifacts, such as uniformity, optical jumps, mis-registration, sacrificing detail, bridging, density variations and the like.

It is desirable to have a document rendering system, such as might be advantageously implied in a PostScript rendering system, which addresses the afford-noted concerns efficiently and effectively.

### SUMMARY OF THE INVENTION

The subject invention teaches a hybrid halftoning system which provides for improved output image rendering. In accordance with the subject invention, electronic document data inclusive of image data is segmented into several regions. These regions include a highlight region, midtone region and a shadow region. Selected dithering schemes are applied to each of these regions.

In accordance with a more limited aspect of the subject invention, dithering patterns applied to the highlight and shadow regions are chosen from selected, dispersed dither patterns. Different dither patterns are selectively applied to the midtone region.

In accordance with a more limited aspect of the subject invention, the midtone region is itself divided into three regions, including a first quarter-tone region, a second quarter-tone region and a central midtone region. A selected dither pattern is provided to each of these subdivided midtone regions, including selective application of an elliptical dither pattern.

In accordance with a more limited aspect of the subject invention, the dither patterns applied to the midtone region include an elliptical pattern provided to a first quarter-tone region and to a second quarter-tone region, and a checkerboard board pattern applied to the central midtone region.

The foregoing, hybridized halftoning system provides for improved halftone rendering, and addresses the above referred problems, and others, and provides a system advantageously used in connection with conventional office document rendering operations, particularly with a PostScript rendering environment.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive

### BRIEF SUMMARY OF THE DRAWINGS

The invention will be described in connection with a series of drawings which are provided for illustrating the preferred and alternative embodiments of the invention only, and not for the purpose of limiting same, wherein:

FIG. 1 is a block diagram of a document processing environment in connection with the subject invention;

FIG. 2 is a flow chart depicting a hybridized dithering of the subject inventions;

FIG. 3 illustrates a segmenting of image regions in connection with the applying the subject, hybridized dithering system;

FIG. 4 illustrates an application of selected dithering patterns to the segmented regions formed in connection with the system of FIG. 3;

FIG. 5 illustrates a representative super cell of the subject halftoning system;

FIG. 6 illustrates a typical, dispersed dot dither pattern used in connection with selected segments of the subject invention;

FIG. 7 illustrates a square dot dither pattern used in connection with selected segments of the subject invention;

FIG. 8 illustrates an elliptical dither pattern used in connection with selected segments of the subject invention;

FIG. 9 illustrates a checkerboard dither pattern used in connection with selected segments of the subject invention;

FIG. 10 illustrates an elliptical dither pattern used in connection with selected segments of the subject invention;

FIG. 11 illustrates an elliptical dither pattern used in connection with selected segments of the subject invention;

FIG. 12 illustrates a square dither pattern used in connection with selected segments of the subject invention; and

FIG. 13 illustrates an elliptical dither pattern used in connection with selected segments of the subject invention.

### DETAILED DESCRIPTION OF THE PREFERRED EMBODIMENT

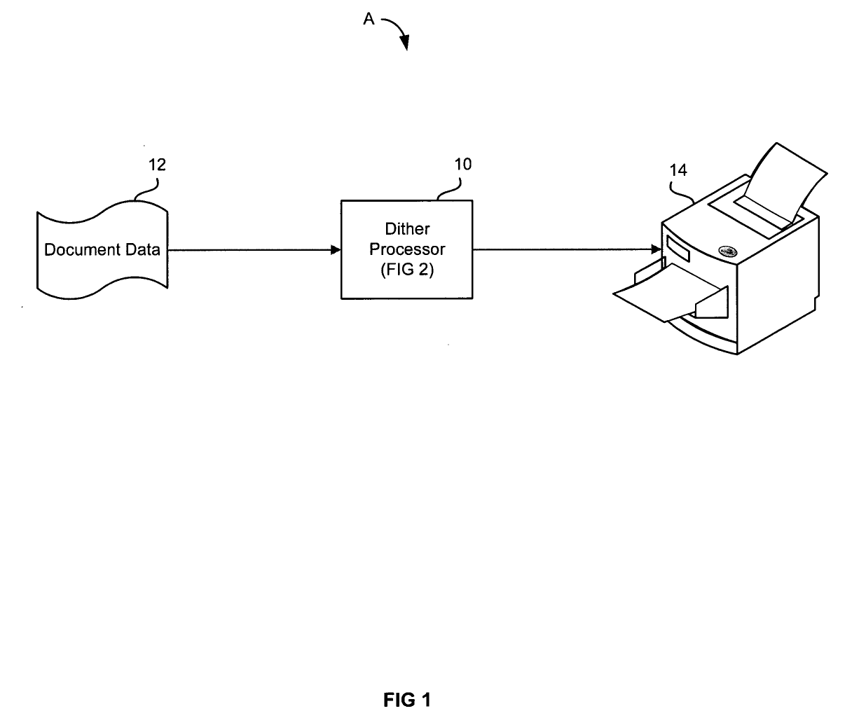

Turning now to the drawings, wherein the depictions are for the purpose of showing the preferred and alternate embodiments only, and, not for the purpose of limiting the same, FIG. 1 illustrates a document rendering system A that includes a dither processor 10 adapted to receive document data 12. Document data 12, once processed by the dither processor 10, is communicated to a document rendering device 14. In the preferred embodiment, document rendering device 14 is comprised of a printer, such as a laser printer, dot matrix printer, ink jet, bubble jet, impact printer, or the like. However, it will be appreciated by one of ordinary skill in the art that the document rendering device is suitably any device that renders an image from pixilated data images, such as expected with the afore-noted printers, as well as LCD displays, DLP displays, and the like.

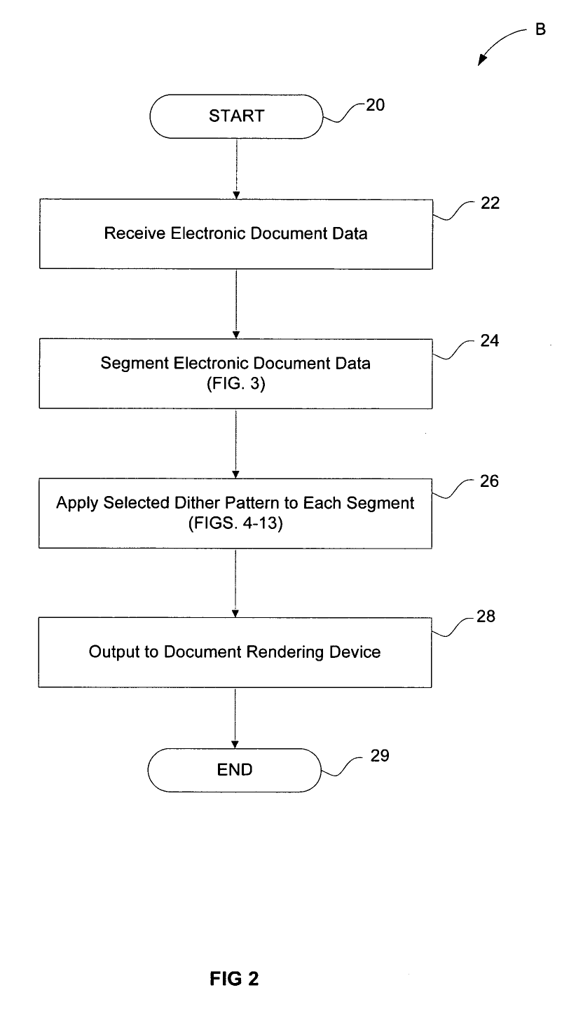

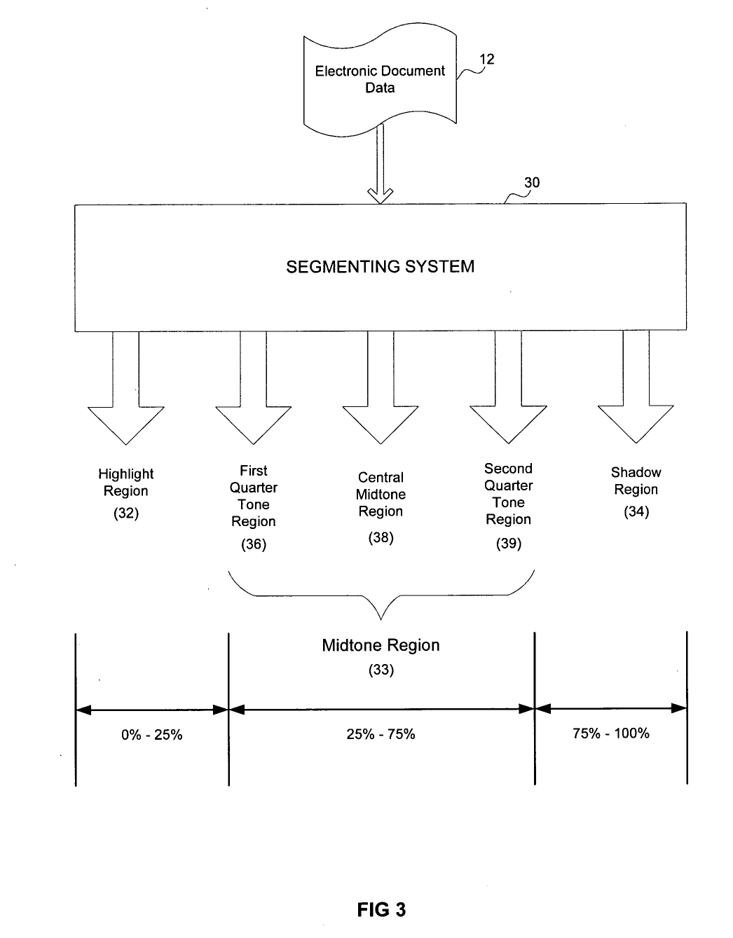

Turning now to FIG. 2, operation of the dither processor 10 of FIG. 1 will be described in more detail. In the flow chart of FIG. 2, a dither processing operation B is commenced at block 20. Next, at block 22, the document data 12 (FIG. 1) is received. Next, progress is made to block 24 wherein a segmenting of electronic data is completed. The segmenting is accomplished in accordance with various gray scale levels or color levels associated with the electronic document data. The segmenting operation of the preferred embodiment will be discussed in greater detail in connection with FIG. 3, below.

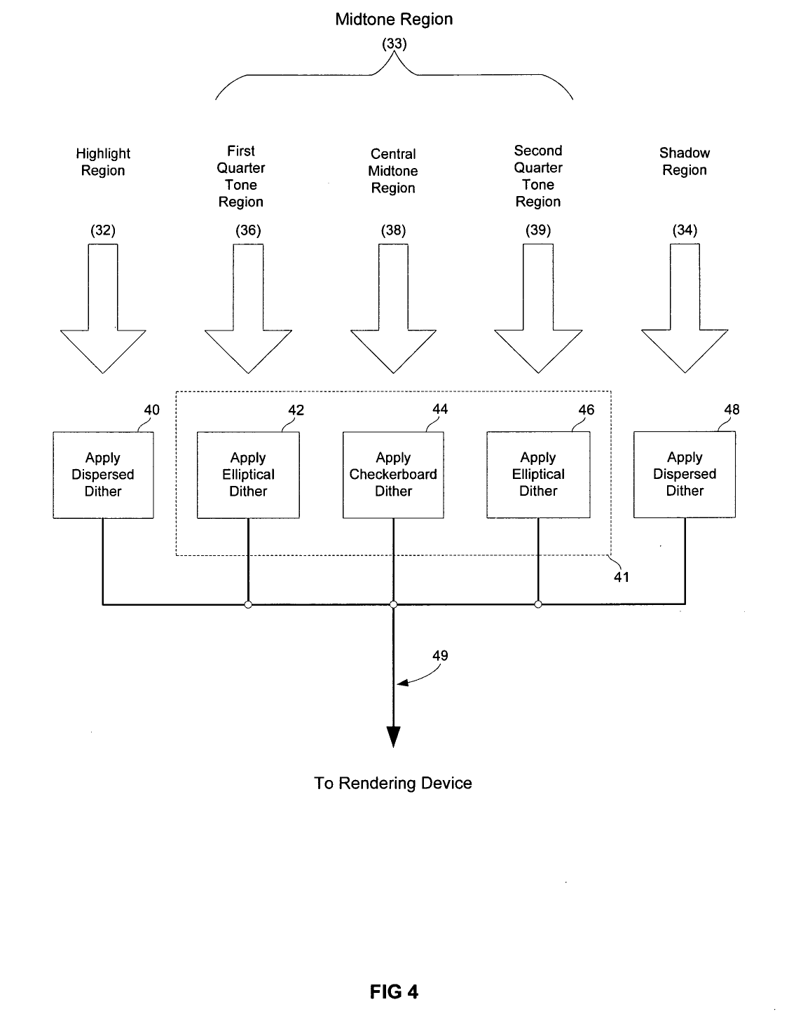

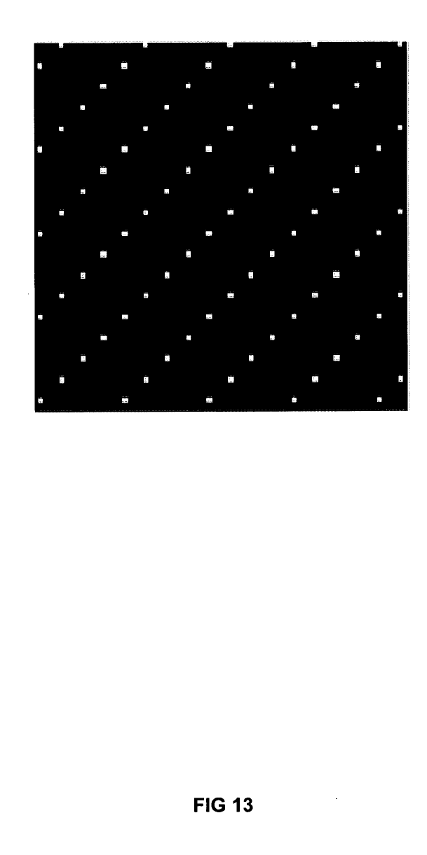

Next, at block 26, application of selected dither patterns to the segments formed in block 24 are made. Particular details as to the selected dithered patterns and their respective application will be described in detail in connection with FIGS. 4-13, below.

Next, at block 28, data to which the subject dithering has been applied is communicated to a document rendering device at block 28, and the process is completed at block 29.

Turning now to FIG. 3, the segmenting of electronic document data from block 24 of FIG. 2 is described in detail. In FIG. 3, electronic document data 12 is communicated to a segmenting system 30 of the dither processor 10 (FIG. 1). It will be appreciated by one of ordinary skill in the art that the segmenting system of the dither processor 10 is suitably realized in any digital processing system, such as in a microprocessor system operated under rendition in any suitable programming language and operating environment with the teaching set forth herein. In segmenting system 30, the electronic document data 12 is analyzed and segmented into a plurality of tonal regions, which tonal regions are suitably segmented relative to a saturation scale of 0 to 100%, wherein 100% denotes full saturation. In the preferred embodiment, the segmenting system 30 isolates the data into a highlight region 32, a midtone region 33 and a shadow region 34. Also, in the preferred embodiment those regions are defined in their conventional sense wherein a highlight region is generally in the range of 0 to 25% saturation, a midtone region is generally in the range of 25% to 75% saturation, and a shadow region is generally in the range of 75% to 100% saturation. However, it is to be appreciated that the advantages of the subject teachings are realized when the ranges vary somewhat from these demarcations. Advantages are realized when the ranges vary by 8-10% from that set forth in the preferred embodiment. As will be appreciated by those skilled in the art, there are three regions—highlight, midtone and shadow—with each region consisting of 85.3 gray levels (256 gray levels/3 regions), with the highlight and shadow regions consisting of 25% of the gray range or 64 levels, thereby resulting in the difference of 22 levels or about 8% of the total gray scale range.

In accordance with a more limited aspect of the subject invention, the midtone region 33 is further divided into three sub-regions. These include a first quarter-tone region 36, a central midtone region 38 and a second quarter-tone region 39. In the preferred embodiment, the central midtone region is at or near a 50% saturation level with a first quarter-tone region and second quarter-tone region adjacent to it on the low saturation side and high saturation side, respectively of the midtone region 33.

Turning now to FIG. 4, application of the selected, hybridized dithering of the subject invention will be described in detail. As depicted in FIG. 4, highlight region data 32 is communicated to a first pattern means 40 which applies a first selected dither pattern. In the preferred embodiment, this first selected dither pattern is a dispersed, or dispersed dot dither pattern. Further description of a suitable dither pattern will be described below.

Midtone region data 33, inclusive of first quarter-tone region data 36, second quarter-tone region data 39 and central midtone region data 38, are communicated to a second pattern means 41. Second pattern means 41 includes a system for selectively applying elliptical dithering image data input thereto. In a preferred embodiment, the second pattern means 41 includes means 42 for applying a selected elliptical dither pattern to first quarter-tone region 36 and means 46 for applying a selected elliptical dither pattern to second quarter-tone region data 39. Also, the system includes a means 44 for applying a checkerboard dither pattern to the central midtone region data 38. More detail relative to the selected dither patterns applied by second pattern means 41 will be described in detail below.

A third pattern means 48 applies a selected dither pattern to shadow region data 34. In a preferred embodiment, a third selected dither pattern is comprised of a dispersed dither pattern, as will be described in more detail below. Once segmented region data has been converted for all of the respective regions, as noted above, it is combined and communicated to a device for image rendering at 49.

Turning next to FIG. 5, illustrated is a super cell or super pixel 50 which is representative of a suitable super cell size in connection with the subject invention. However, it is appreciated that various array sizes of super cells are contemplated in connection with the subject invention. A particular cell choice is application specific to a particular rendering device and color palate as will be appreciated by one of ordinary skill in the art. In the illustrated embodiment of FIG. 5, the super cell 50 is formed from an array of 16×16 device dots. It will be appreciated by one of ordinary skill in the art that this is by way of example only, and that suitable cells or any rectangular array, and are square in the preferred embodiment, and are suitably 3×3, 9×9, 5×5, 6×6, 7×7, or any particular resolution which may be advantageous for a particular application.

In the illustrated embodiment of FIG. 5, super cell 50 includes a plurality of device dots, such as the represented ones listed at 52 and 54. A sub cell is suitably defined as being comprised of 4×4 or 16 device dots. Thus, each super cell consists of four sub cells. A total of 256 gray levels are suitably realized with the illustrated super cell. The afore-noted disbursement patterns are accordingly represented in connection with a super cell, such as that provided in FIG. 5.

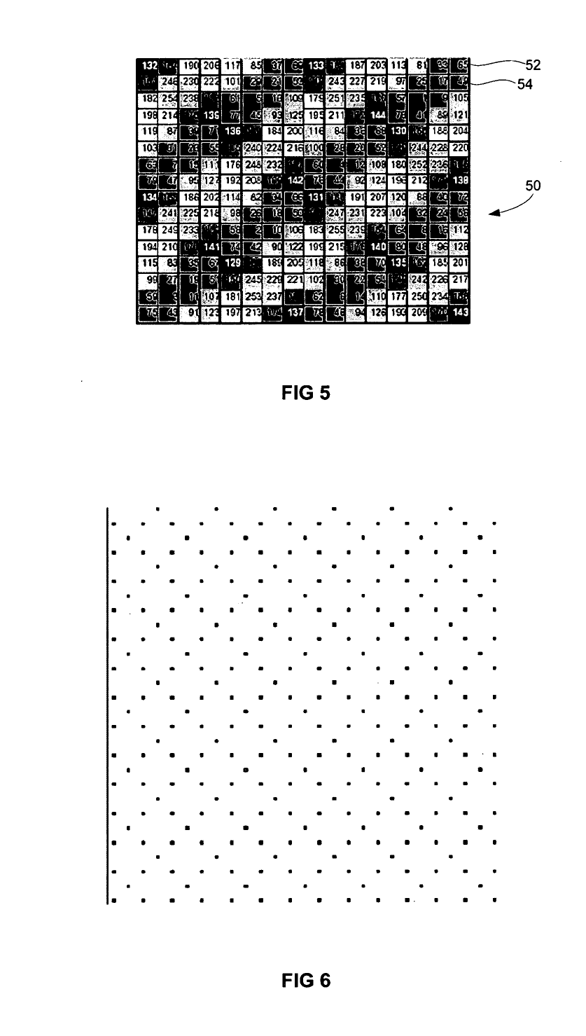

Turning next to FIG. 6, illustrated is a typical dispersed pattern of dots, such as that suitably used for the highlight region. Such a disbursed pattern advantageously provides widely-spaced dots to produce a constantly uniform tone in these areas and is representative of the highlight patterns.

Turning now to FIG. 7, illustrated is a regular pattern of square dots which is also suitably used in connection with highlight dithering, located at the end of the highlight range. As with the dispersed pattern, this one also advantageously yields results that are consistently uniform in tone.

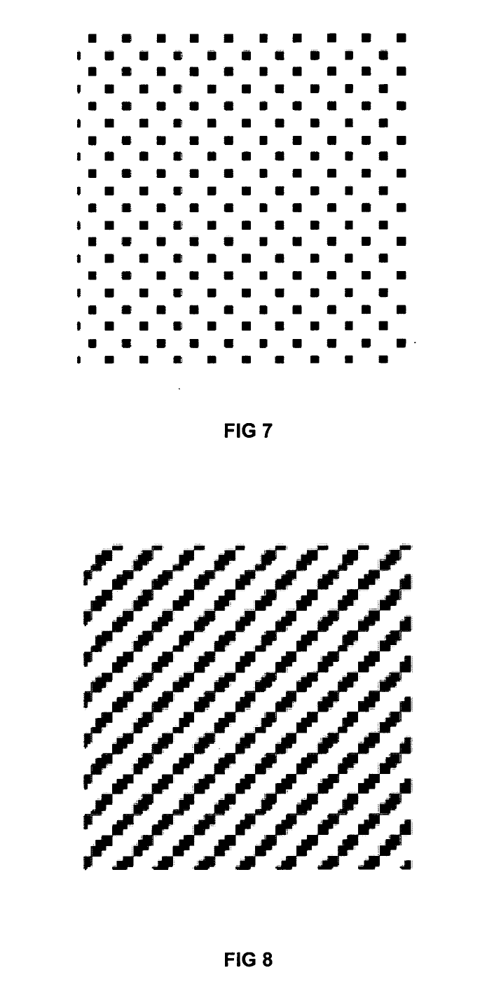

Turning now to FIG. 8, illustrated is a suitable dither of ellipse shaped cells. Such an ellipse pattern is that which is advantageously applied to the midtone region 33, and particularly in the first quarter-tone region.

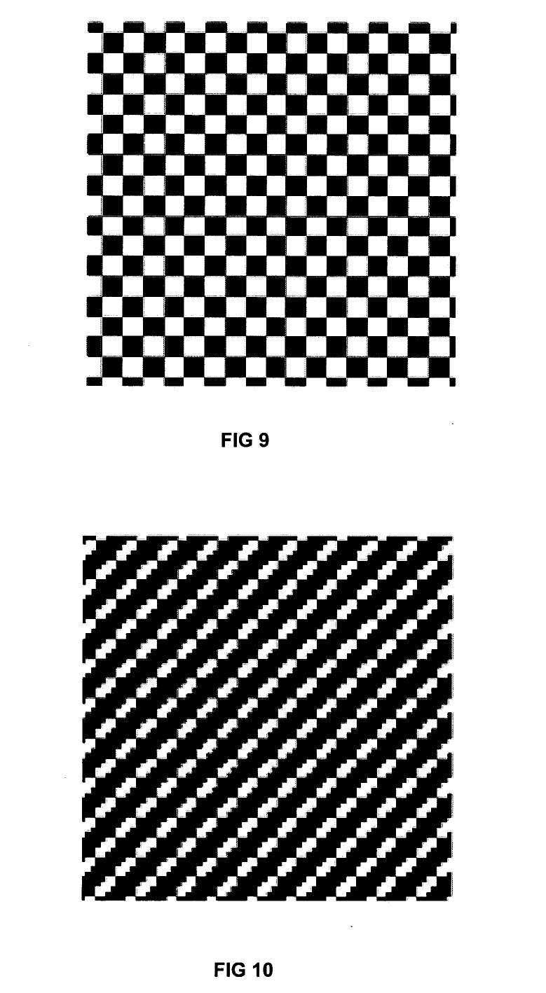

Turning next to FIG. 9, illustrated is a representative checkerboard pattern or checkerboard dithered pattern which is suitably applied at or around a 50% total level, as noted in connection with the central midtone region 38. The checkerboard pattern advantageously provides a transition point from cells with black dots to cells with white dots or voids, as is provided in the subject halftone pattern scheme.

FIG. 10 illustrates an elliptical dithering pattern such as is suitably employed in connection with second quarter-tone region 39 of midtone region 33. Such elliptical dots advantageously provide a control for dot gain. It will be noted that the elliptical pattern of FIG. 10 is a reverse version of that in FIG. 8, as is attributed to being in at a higher relative saturation level.

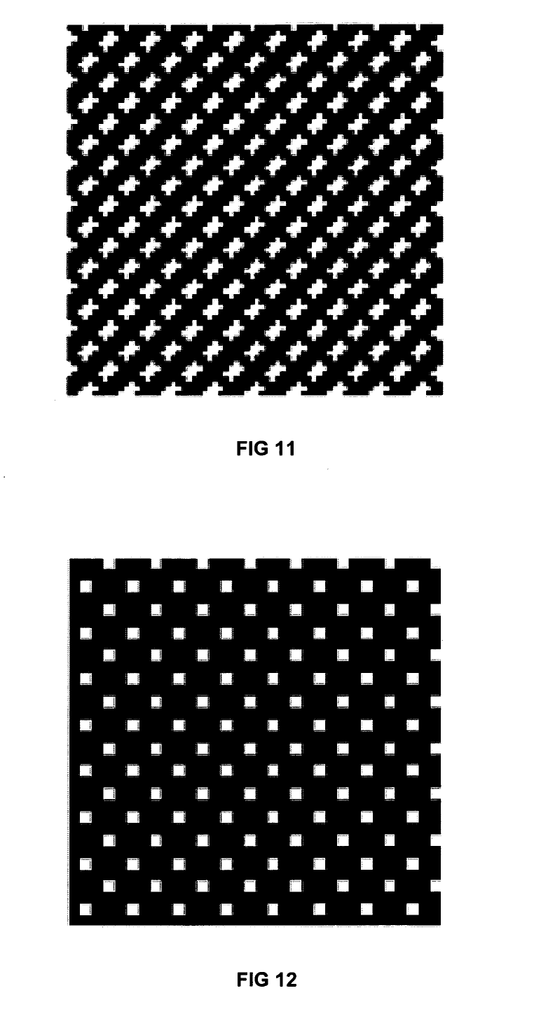

FIG. 11 illustrates a square shaped dot as suitably used in connection with a second quarter-tone region 39 of midtone region 33. As with the elliptical dithering pattern disclosed in FIG. 10, this elliptical pattern provides a consistently uniform tone.

FIG. 12 illustrates a dispersed dot dither pattern suitably implemented and a shadow region, such as that provided in region 34. This selected dither pattern advantageously provides consistently uniform tones.

As will be appreciated from the progression from FIGS. 6 through 13, a primary dot growth direction is provided at 45 degrees. This angle is chosen insofar as it provides a least visible screen angle. Dispersed dithers grow according to an even distance dot repeat in both the 45 degree direction and the horizontal and vertical direction. A checkerboard provides for even distance dot repeat in both the horizontal and vertical directions.

While the subject invention has been described with illustration to a gray scale, it would be readily appreciated that the subject invention is equally applicable to color space renderings, such as that provided by red, green and yellow, cyan, magenta, yellow and black, or red, green and blue. It is to be further appreciated that any other chosen color space may suitably benefit by application of the subject-hybridized dither technique.

It is to be further appreciated that the super cell, such as that illustrated by FIG. 5, is repeated many times across a source images plane. During such rendering, a gray scale pixel value of the source image is converted to a halftone screen by turning on a same number of dots in the arrays growth order. By way of example, a 50% tone turns on half of the device dots configured and the checkerboard pattern, such as that illustrated in connection with FIG. 9.

From the foregoing, it will be appreciated that as a source image density increases and halftone dot size increases, a dot gain also increases, resulting in density reproduction areas. When a dot configuration can no longer consist of dispersed single dots as shown in FIG. 6, the dots are configured to group together, but remain separated. Commonly share sides of device dot groups limits dot gain. When dot growth no longer allows for separated dot, then a group of device dots within each sub cell forms an elliptical shape, limiting density gain in a single direction. When dot growth requires that dots touch in both primary and secondary directions, then a dot configuration is a checkerboard pattern. While such a checkerboard pattern results in a greatest increase in dot gain, it also maintains a high screen frequency, and serves as a transition level for inverting a dot growth pattern. Thus, voids between black dots decrease in a same manner as black dots grow in size and configuration. Thus, the advantage is realized by the subject invention are provided.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled

What is claimed is:

1. A hybrid halftoning system comprising:
means adapted for receiving electronic document data representative a document image, wherein the electronic document data includes data representative of a plurality of image portions selected from a highlight region, a midtone region and a shadow region; and
dither means, the dither means including,
first pattern means for selectively applying a first selected dither pattern to at least a first image portion in the highlight region,
second pattern means for selectively applying a second selected dither pattern to at least a second image portion in the midtone region, and
third pattern means for selectively applying a third selected dither pattern to at least a fourth image portion in the shadow region.

2. The hybrid halftoning system of claim 1, wherein the midtone region is generally in the range of 25% to 75% of image values associated with the electronic document data.

3. The hybrid halftoning system of claim 1, wherein the first selected dither pattern 5 and the third selected dither pattern include a dispersed dither pattern, and wherein the second dither pattern includes an elliptical dither pattern.

4. The hybrid halftoning system of claim 2, wherein the midtone region is comprised of a first quarter-tone region, a second quarter-tone region, and a central midtone region, and wherein the second pattern means includes:
means adapted for applying the second selected dither to the first and second quarter-tone regions; and
means adapted for applying a central midtone dither pattern to the central midtone region.

5. The hybrid halftoning system of claim 4, wherein:
the first and third selected dither patterns include a dispersed dither pattern;
the first and second selected dither portions includes an elliptical dither pattern; and
the central midtone dither pattern includes checkerboard dither pattern.

6. The hybrid halftoning system of claim 5, wherein the electronic document data is encoded in a color space selected from one of: a) red, green and yellow; b) cyan, magenta, yellow and black; and c) red, green and blue.

7. A method of hybrid halftoning comprising the steps of:
receiving electronic document data representative a document image, wherein the electronic document data includes data representative of a plurality of image portions selected from a highlight region, a midtone region and a shadow region;
applying a first selected dither pattern to at least a first image portion in the highlight region;
applying a second selected dither pattern to at least a second image portion the midtone region; and
applying a third selected dither pattern to at least a fourth image portion in the shadow region.

8. The method of hybrid halftoning of claim 7, wherein the midtone region is generally in the range of 25% to 75% of image values associated with the electronic document data.

9. The method of hybrid halftoning of claim 7, wherein the first selected dither pattern and the third selected dither pattern include a dispersed dither pattern, and wherein the second dither pattern includes an elliptical dither pattern.

10. The method of hybrid halftoning of claim 8, wherein the midtone region is comprised of a first quarter-tone region, a second quarter-tone region, and a central midtone region, and further comprising the steps of:
applying the second selected dither to the first and second quarter-tone regions; and
applying a central midtone dither pattern to the central midtone region.

11. The method of hybrid halftoning of claim 10, wherein:
the first and third selected dither patterns include a dispersed dither pattern;
the first and second selected dither portions includes an elliptical dither pattern; and
the central midtone dither pattern includes checkerboard dither pattern.

12. The method of hybrid halftoning of claim 11, wherein the electronic document data is encoded in a color space selected from one of: a) red, green and yellow; b) cyan, magenta, yellow and black; and c) red, green and blue.

13. A hybrid halftoning system comprising:
means adapted for receiving electronic document data representative a document image, wherein the electronic document data includes data representative of a plurality of image portions selected from a highlight region, a first quarter-tone region, a second quarter-tone region, a central midtone region and a shadow region, wherein the first, second and central midtone regions contiguously define a range of generally 25% to 75% of image values associated with the electronic document data; and
dither means, the dither means including,
highlight region pattern means for selectively applying a shadow region dither pattern to an image portion in the highlight region,
first quarter-tone pattern means for selectively applying a first quarter-tone dither pattern to an image portion the first quarter-tone region,
second quarter-tone pattern means for selectively applying a second quarter-tone dither pattern to an image portion the second quarter-tone region,
central midtone pattern means for selectively applying a central midtone dither pattern to an image portion of the central midtone region, and
shadow region pattern means for selectively applying a shadow region dither pattern to at least the image portion in the shadow region.

14. The hybrid halftoning system of claim 13, wherein:
the highlight region dither pattern includes a dispersed dither pattern;
the first quarter-tone dither pattern includes an elliptical dither pattern;
the central midtone region includes a checkerboard dither pattern;
the second quarter-tone pattern includes an elliptical dither pattern; and
the shadow region dither pattern includes a dispersed dither pattern.

15. The hybrid halftoning system of claim 13, wherein:
a selected, common dither pattern is included in both the highlight region dither pattern and the shadow region dither pattern.

16. The hybrid halftoning system of claim 13, wherein:
a selected, common halftone dither pattern is included in both the first quarter-tone dither pattern and the third quarter-tone dither pattern.

17. The hybrid halftoning system of claim 15, wherein:
a selected, common half-tone dither pattern is included in both the first quarter-tone dither pattern and the third quarter-tone dither pattern.
